(19) United States
(12) Patent Application Publication
(10) Pub. No.: US 2018/0114282 A1
(43) Pub. Date: Apr. 26, 2018

(54) METHODS, SYSTEMS, AND COMPUTER READABLE MEDIA FOR ELECTRONICALLY MANAGING THE OPERATION OF A THERMOSTAT DEVICE

(71) Applicant: MasterCard International Incorporated, Purchase, NY (US)

(72) Inventor: Rick Bernard Unnerstall, O'Fallon, MO (US)

(21) Appl. No.: 15/331,764

(22) Filed: Oct. 21, 2016

(51) Int. Cl. G06Q 50/06; G06Q 20/40; G06Q 20/32

(52) U.S. Cl. CPC G06Q 50/06; G06Q 20/3278; G06Q 20/40

(57) ABSTRACT

Methods, systems, and computer readable media for electronically guaranteeing rent payment are provided. An exemplary method includes electronically receiving, by a payment program platform, monetary funds to be deposited in a payment card account hosted by the payment program platform and designating at least a portion of the received monetary funds as allocated rent payment funds in accordance to a rent payment policy. The method further includes electronically providing the allocated rent payment funds to a rent payment management server (HPMS) for storage and electronically releasing, by the HPMS, an accumulated amount of monetary funds that includes the allocated rent payment funds to a rental property owner in accordance to the rent payment policy.

### TECHNICAL FIELD

The subject matter described herein relates to improved methods and systems for electronically managing and adjusting heating, ventilating, and air conditioning (HVAC) services. More particularly, the subject matter described herein relates to systems, methods, and computer readable media for electronically managing the operation of a thermostat device.

### BACKGROUND

At present, a rental property owner leasing a property on a short-term basis typically enters weekly or monthly rental agreements for the property with a number of different renters. It is not uncommon that renters may utilize a thermostat device on the property to adjust the temperature over a wide range during their respective stays. In some instances, renters may liberally adjust the temperature within the rental property to achieve various comfort levels. Such behavior by the renter(s) may result in significant heating and cooling costs for the rental property owner. Restrictive measures, such as locking the thermostat device to a predefined and/or designated temperature (or restricted temperature range), may remedy the excessive heating and cooling costs for the rental property owner but may be inconvenient, uncomfortable, and impractical for the renters.

Accordingly, there exists a need for improved methods, systems, and computer readable media for electronically managing the operation of a thermostat device.

### SUMMARY

According to one aspect, the subject matter described herein relates to methods, systems, and computer readable media for electronically guaranteeing rent payment. An exemplary method includes receiving, by a thermostat device, an input signal requesting local operation of the thermostat device for a designated time period, wherein the input signal includes payment credential data and electronically sending, by the thermostat device to a reservation management host server, a reservation request message including the payment credential data and a token identifier corresponding to the thermostat device. The method further includes electronically receiving, by the thermostat device from the reservation management host server, a control message sent in response to an approval of the payment credential data and permitting, in response to the received control message, the local operation of the thermostat device for the designated time period.

An exemplary system includes a thermostat device configured to receive an input signal requesting local operation of the thermostat device for a designated time period, wherein the input signal includes payment credential data, and to electronically send a reservation request message including the payment credential data and a token identifier corresponding to the thermostat device. The system further includes a reservation management host server configured to receive the reservation request message, to obtain approval for the payment credential data, and to send a control message to the thermostat device in response to the approval of the payment credential data, wherein the local operation of the thermostat device is permitted for the designated time period in response to the control message being received by the thermostat device.

The subject matter described herein may be implemented in hardware, software, firmware, or any combination thereof. As such, the terms “function”, “node”, or “module” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps.

Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The subject matter described herein includes exchanging messages across a packet-based communications network, wherein the messages include payloads containing payment information (payment card numbers, account data, or the like), balance information, and/or transaction information associated with guaranteeing the electronic payment of rent. The subject matter described herein also includes implementing electronic pre-allocation or designation of monetary funds, to effectively place a hold (e.g., place a lien, store in escrow, etc.) on those funds until a predetermined settlement date such that the funds can only be used for rent payments. In some embodiments, implementing an electronic guarantee for rent payments includes invoking one or more application programming interfaces (APIs) configured to assist otherwise distinct applications with sharing data across a packet-based network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating exemplary network architecture for electronically managing the operation of a thermostat device according to an embodiment of the subject matter described herein;

FIG. 2 is a diagram illustrating exemplary electronic messaging exchanged between various network entities for electronically managing the operation of a thermostat device according to an embodiment of the subject matter described herein;

FIG. 3 is a block diagram illustrating an exemplary reservation management host server for electronically managing the operation of a thermostat device according to an embodiment of the subject matter described herein; and

FIG. 4 is a flow diagram illustrating an exemplary method for electronically managing the operation of a thermostat device according to an embodiment of the subject matter described herein.

### DETAILED DESCRIPTION

In accordance with the subject matter disclosed herein, methods, systems, and computer readable media for electronically managing the operation of a thermostat device are provided. In some embodiments, a thermostat device may be equipped with advance payment capabilities that enable rental property owners the opportunity to reduce HVAC variable costs and increase revenues by implementing an “advance payment and reservation” model for customers/renters that rent their commercial and/or residential properties. In scenarios where the thermostat device is not being used (e.g., an idle state), the thermostat device may revert to the rental property owner's pre-configured or default settings (i.e., to reduce heating and cooling costs). Notably, the default setting may be locked in a manner in which local and/or manual operation by the renter is prohibited. This new functionality afforded by the disclosed subject matter may be used to prevent HVAC usage abuse at a rental property and/or the like. Further, the thermostat device may be equipped with a communication module that is configured to receive an input signal (e.g., via a wireless near field communications (NFC) tap or a manual input on a user interface screen of the thermostat device) from a renter that indicates a request to be permitted operational access and control of the thermostat device for a predefined period of time. The system may also be configured to provide rental property owners the ability to review historical HVAC usage data, which can be analyzed to better control variable costs associated with the leasing of residential or commercial rental properties.

In some embodiments, the methods, systems, and computer readable media described herein for electronically managing the operation of a thermostat device are not manual (e.g., incapable of being entirely performed or executed by a human being), but rather are accomplished by virtue of electronic messaging exchanged between network entities (e.g., computer platforms, electronic entities, or nodes) across a packet-based communications network. The methods, systems, and computer media described herein advantageously obviate the need for performing manual processes (e.g., manually unlocking a thermostat control, designating specific electronic deposits for permitting the operation of thermostat device, etc.) on a recurring basis, thereby enabling rental property owners to monetize (and/or subsidize) HVAC services associated with a particular rental property.

Reference will now be made in detail to exemplary embodiments of the subject matter described herein, examples of which are illustrated in the accompanying drawings. Wherever possible, the same reference numbers will be used throughout the figures and refer to the same or like entities.

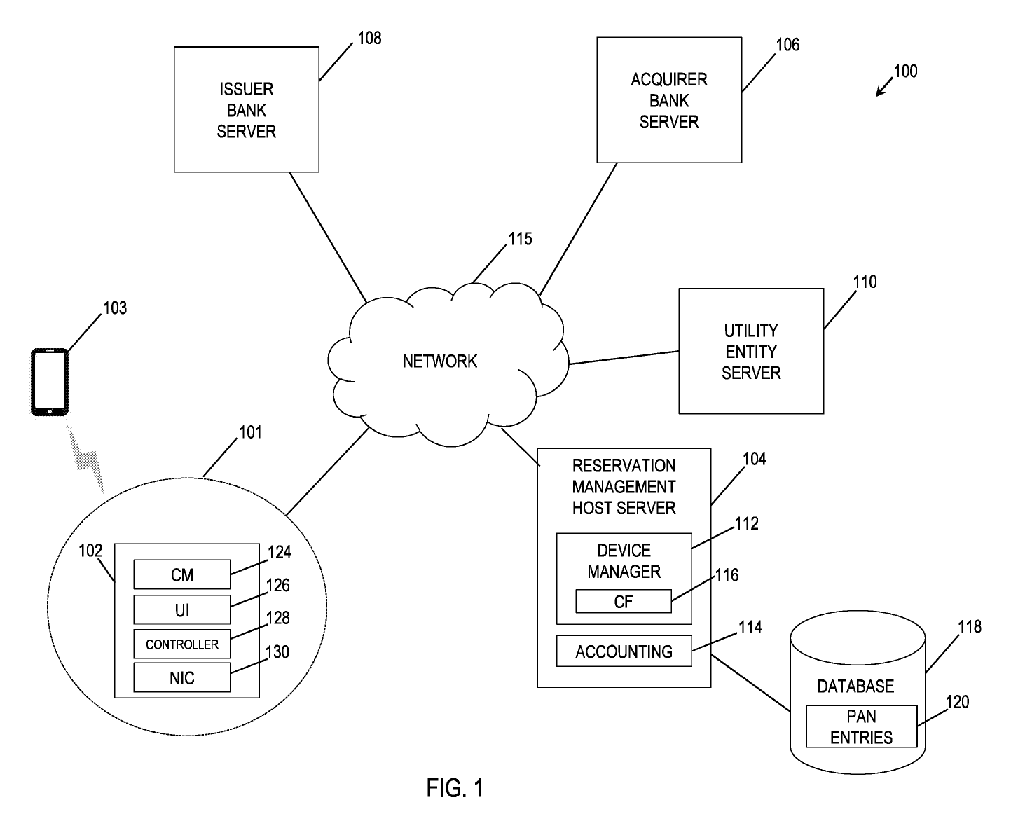

FIG. 1 is a schematic diagram illustrating an exemplary network environment or network system 100 associated with electronically managing the operation of a thermostat device 102 according to an embodiment of the subject matter described herein. In some embodiments, system 100 includes different and/or distinct network nodes or entities for facilitating the electronic management of thermostat device 102. For example, system 100 may include at least one thermostat device 102, a reservation management host server 104, an acquirer bank server 106, an issuer bank server 108, and a utility entity server 110 that are communicatively connected via a communications network 115. Although only one thermostat device 102 is shown in FIG. 1, additional thermostat devices may be managed within system 100 without departing from the scope of the disclosed subject matter.

In some embodiments, communications network 115 includes a packet-based communications network (e.g., the Internet) that is utilized and/or accessed by thermostat device 102 and servers 104-110 via a communications interface. Although a packet-based network is shown for illustrative purposes, the subject matter described herein is not limited to a packet-based network. Any type of communications network through which messages can be exchanged electronically between computing platforms may be used without departing from the scope of the subject matter described herein. Such communications networks may include packet-based networks, circuit-switched networks, and combinations of packet-based and circuit-switched networks. Although not shown, each individual entity (e.g., elements 102, 104, 106, 108, and 110) associated with system 100 may reside in an individual (e.g., public or private) network, which may include a same network or different networks, and are not shown for illustration purposes. Network 115 facilitates communication of data via packets or packet-based messages, which may be communicated between network entities according to any desired communication protocol as known in the art (e.g., IP, HTTP, TCP, UDP, SIP, or the like).

As indicated above, system 100 may include at least one thermostat device 102 that comprises a hardware based device configured to measure and manage the air temperature of a given area 101 (e.g., one or more rooms in an rental property area and/or living space). Thermostat device 102 may also be configured to regulate the heating and cooling facilities of area 101 to maintain the ambient air temperature at a particular set point temperature. In some embodiments, thermostat device 102 may be programmed by its owner to operate at a default setting (e.g., a predefined and/or default set point temperature) in certain situations. As shown in FIG. 1, thermostat device 102 may include a wireless communications module 124 (e.g., an NFC module, EMV module, radio frequency identification (RFID) module, and the like), a user interface (UI) 126, a controller 128, and a network interface card (NIC) 130.

In some embodiments, components 124-130 of thermostat device 102 collectively enable a renter/user to request and reserve local control of thermostat device 102 for a defined period of time. For example, wireless communications module 124 may facilitate the receiving of an input signal from a user device 103 (e.g., a smart phone, tablet computer, laptop computer and/or other mobile device) utilized by the renter. In some embodiments, thermostat device 102 may include a hardware-based NFC module that enables thermostat device 102 to exchange NFC signals with a similarly NFC-enabled user device (e.g., device 103). The input signal from the user device may include a renter identifier (e.g., a mobile device number, such as a MSISDN) and payment credential data (e.g., the renter's credit card or debit card credentials) and serve as a request to locally operate thermostat device 102 for a designated time period. After communicating the input signal via the user device 103, a renter user may request a reservation duration or time period in which the renter wishes to have access and local control over thermostat device 102. In some embodiments, the time period may be defined utilizing user interface 126 (e.g., selecting/designating a one-week period of time via a touchscreen display on the thermostat device). In particular, thermostat device 102 may be configured such that, when unlocked/enabled by controller 128, user interface 126 allows a renter/user to control, manage, and/or operate thermostat device 102 (e.g., adjust the set point temperature, turn thermostat device 102 on or off, etc.). User interface 126 may include any interface that enables a user to manually operate the device, such as a touch screen, one or more push buttons, one or more sliding levers, and the like.

Thermostat device 102 may also be equipped with a controller 128. In some embodiments, controller 128 may be configured to generate a reservation request message upon thermostat device 102 wirelessly receiving the input signal and/or payment credential data from the renter's user device 103. For example, a reservation request message generated by thermostat device 102 may include the payment credential data, a token identifier (e.g., a token primary account number (PAN) that uniquely identifies thermostat device 102), and the requested reservation time period data. Controller 128 may also be configured to send the reservation request message to reservation management host server 104 via network interface controller 130 (as described below).

In addition to generating and sending output messages (e.g., reservation request messages), controller 128 may also be configured to process received messages and commands that are directed to thermostat device 102 (e.g., control messages sent by reservation management host server 104). Notably, controller 128 may be responsible for configuring the access and operation of thermostat device 102 based on instructions and commands encoded in the control messages received from reservation management host server 104. For example, controller 128 may be configured to permit a renter/user to locally operate thermostat device 102 upon receiving a related device operation control message from reservation management host server 104. In some examples, a received device operation control message may include an activation code that is recognized by and instructs controller 128 to permit local operation of thermostat device 102. Further, in some embodiments, the device operation control message may also include a specified reservation duration that is managed (e.g., kept track of) by controller 128. Controller 128 may include and/or utilize a clock function that may be configured to keep track of dates and/or times associated with a reservation duration specified in the device operation control message. Upon detecting/recognizing the expiration of the specified reservation duration, controller 128 may be configured to terminate the local operational accessibility of thermostat device 102 (e.g., render UI 126 temporarily inoperable, ignore commands regarding temperature control via UI 126, etc.). In alternate embodiments, controller 128 may be configured to receive a control termination message that includes a termination code that is recognized by and instructs controller 128 to immediately disable the temperature controls thermostat device 102. Upon receiving such a control termination message, controller 128 may also be configured to set the temperature set point of thermostat device 102 to a predefined and/or default temperature value.

As indicated above, thermostat device 102 may also include a network interface card (NIC) 130. Notably, network interface card 130 enables thermostat device 102 to communicate with other network entities via network 115. For example, thermostat device 102 may access network 115 via NIC 130, which facilitates signaling across any type of wired or wireless connection or interface (e.g., a WAN, a LAN, a WiFi connection, a radio access network connection, or the like). In some embodiments, NIC 130 of thermostat device 102 may establish a connection with a router and/or modem device (e.g., a wireless router) located in area 101 in order to gain access to communication network 115.

In some embodiments, system 100 further includes reservation management host server 104 that may be managed by a payment network entity (e.g., MasterCard® payment network). In some embodiments, reservation management host server 104 is configured to receive a reservation request message from thermostat device 102. As indicated above, the reservation request message may include a renter's payment credential data, a token identifier (e.g., a token PAN), and a requested reservation duration sent by thermostat device 102. In some embodiments, reservation management host server 104 maintains a database 118 that includes primary account number (PAN) entries 120 that establish correlations between a rental property owner's PAN and its associated token PANs. For example, each entry of database 118 may include a main property owner PAN (or other identifier) that is assigned to a rental property owner. Notably, the database entry also includes one or more mappings existing between the PAN and a respective one or more token PANs. Each token PAN that is mapped to the main property owner PAN may uniquely identify or correlate with a thermostat device owned by the property owner (e.g., a plurality of thermostat devices respectively associated with a plurality of rental properties owned by a single owner). For example, a rental property owner that owns five thermostat devices may have five separate token PANs mapped to his/her single property owner PAN. By mapping the token PANs to the single property owner PAN in this manner, monetary funds submitted as payment from renters may be readily correlated and applied to the property owner's account.

In some embodiments, reservation management host server 104 may be configured to issue a payment authorization request. Specifically, the payment authorization request is subsequently sent to an appropriate acquirer bank server 106 in response to receiving a reservation request from thermostat device 102. In some embodiments, acquirer bank entity server 106 is associated with an acquiring bank entity, such as a bank, credit union, or some other financial institution, that processes payment card payments (e.g., credit card or debit card payments) on behalf of the reservation management host server 104 and/or a subscriber user (e.g., rental property owner). For example, reservation management host server 104 may send a payment authorization request that includes the renter's payment credential data to acquirer bank server 106.

The acquirer bank server 106 may then forward the payment authorization request, via a payment network processing server (not shown), to an issuer bank server 108 responsible for issuing the payment card used by the renter initiating the thermostat device reservation request transaction. After processing the payment authorization request originally sent by acquirer bank server 106, issuer bank server 108 may send an authorization code that serves as an indication that the renter's payment has been authorized and/or approved to acquirer bank server 106 via the payment network processing server. In response to receiving the authorization code, acquirer bank server 106 then sends an authorization notification message to reservation management host server 104.

Upon receiving the authentication notification from acquirer bank server 106, reservation management host server 104 may generate a reservation for the control and/or operation for thermostat device 102. For example, payment network server 104 may use a calendar function to create a unique reservation for thermostat device 102 using the received requested reservation time period data, the renter's payment credential data, and unique token identifier corresponding to thermostat device 102 originally received in the reservation request message previously sent by thermostat device 102.

After the reservation is generated, reservation management host server 104 is configured to create and send a device operation control message to thermostat device 102 via network 115. In some embodiments, the control message is directed to the Internet protocol (IP) address (which may have been previously recorded upon receiving the original reservation request message) associated with thermostat device 102. In some embodiments, the IP address may be an address assigned specifically to thermostat device 102 or an IP address corresponding to a modem and/or router in area 101 (not shown) that is responsible for communicatively connecting thermostat device 102 to network 115. Notably, the control message may include an activation code that is recognized by controller 128 on thermostat device 102. In some embodiments, controller 128 may be configured to unlock the inaccessibility of user interface 126 of thermostat device 102 upon detecting the activation code, thereby enabling a renter to locally operate and adjust thermostat device 102. In some embodiments, thermostat device 102 and reservation management host server 104 (and/or a device manager 112) communicate and/or exchange message requests and control messages via an application programming interface (API) configured to facilitate the communication of data and messages. Communications exchanged between reservation management host server 104 and other network entities (e.g., thermostat device 102 and servers 106-110) may include packets having payload data containing account information (e.g., a payment card credential data (e.g., a PAN or some other account and/or identifier number), reservation durations, token identifiers, a rental property owner PAN identifier, a thermostat device identifier (e.g., a token identifier), and/or renter identification information.

In some embodiments, device manager 112 may utilize an API to establish communications with acquirer bank server 106, issuer bank server 108, and utility entity server 110. As used herein, utility entity server 110 may include a host server associated with an electric power company. Utility entity server 110 may, upon request from device manager 112, provide usage data to reservation management host server 104. The usage data may provide data pertaining to the power consumption and/or usage associated with a particular location and/or thermostat device. Notably, such usage data may be forwarded by device manager 112 to an accounting manager 114 upon receipt. In some examples, accounting manager 114 is a component residing in reservation management host server 104 that is configured to manage thermostat account information and present such information to the rental property owner in a historical report. For example, accounting manager 114 may generate reports by which the rental property owner can utilize to assess historical power consumption and/or usage metrics and billed amounts associated with a thermostat device. In particular, the rental property owner may view past utility bills and/or payments, set up a calendar reservation schedule, view a particular thermostat account balance, or the like. In some embodiments, device manager 112 and accounting manager 114 may be stored in local memory of reservation management host server 104 and are executed by at least one processor (not shown) in server 104.

In some embodiments, reservation management host server 104 may be configured to process usage data that is available from utility entity server 110 (e.g., a power company host server) in order to model price points. In particular, model price point data for a given rental property may be derived from historical usage data corresponding to the rental property itself or historical usage data associated with similar properties (e.g., other rental properties with similar location and/or size). Notably, reservation management host server 104 may apply the derived price point to a payment transaction upon receiving a reservation request message from a renter via thermostat device 102. For example, if the historical usage data indicates that a given rental property had a July 2014 HVAC bill amounting to $100 then reservation management host server 104 may set a price point of $50 to operate the thermostat device during a July 2015 reservation (e.g., server 104 may anticipate a $0-$50 increase or premium over the typical $100 needed to cool the rental property above a default temperature set point).

In some embodiments, reservation management host server 104 may communicate with a weather service host server (not shown) and acquire weather forecast data. In particular, reservation management host server 104 may query the weather service host server to obtain predicted temperatures (e.g., daily high and low temperatures) for any number of forthcoming days. In some embodiments, reservation management host server 104 may use the forecasted temperature data associated with a particular location (e.g., the rental property location) and a time period (e.g., a particular week or month) in order to estimate a price point or range associated with heating or cooling costs. Notably, device manager 106 in reservation management host server 104 may be configured to utilize the forecasted temperature data to derive a minimum reservation rate or flat fee for a particular thermostat device and rental property.

Notably, network entities, including thermostat device 102 and reservation management host server 104, are special purpose computing devices or machines that each includes hardware components (e.g., one or more processor units, memory, and/or network interfaces) configured to execute hardware and software elements (e.g., APIs, computing modules, etc.) for the purposes of performing one or more aspects of the disclosed subject matter. In addition, it should be noted that reservation management host server 104 and thermostat device 102, the functionality and/or components thereof described herein constitute special purpose computers that improve the technological field of managing the operation control of thermostat device.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., reservation management host server 104, device manager 112, or some functionality thereof may be integrated with any other entities associated with system 100. Further, although FIG. 1 describes the management and operation of a thermostat device 102, the methodology and system may be applied to other rental property devices or services, such as a broadband service and/or a broadband router without departing from the scope of the disclosed subject matter.

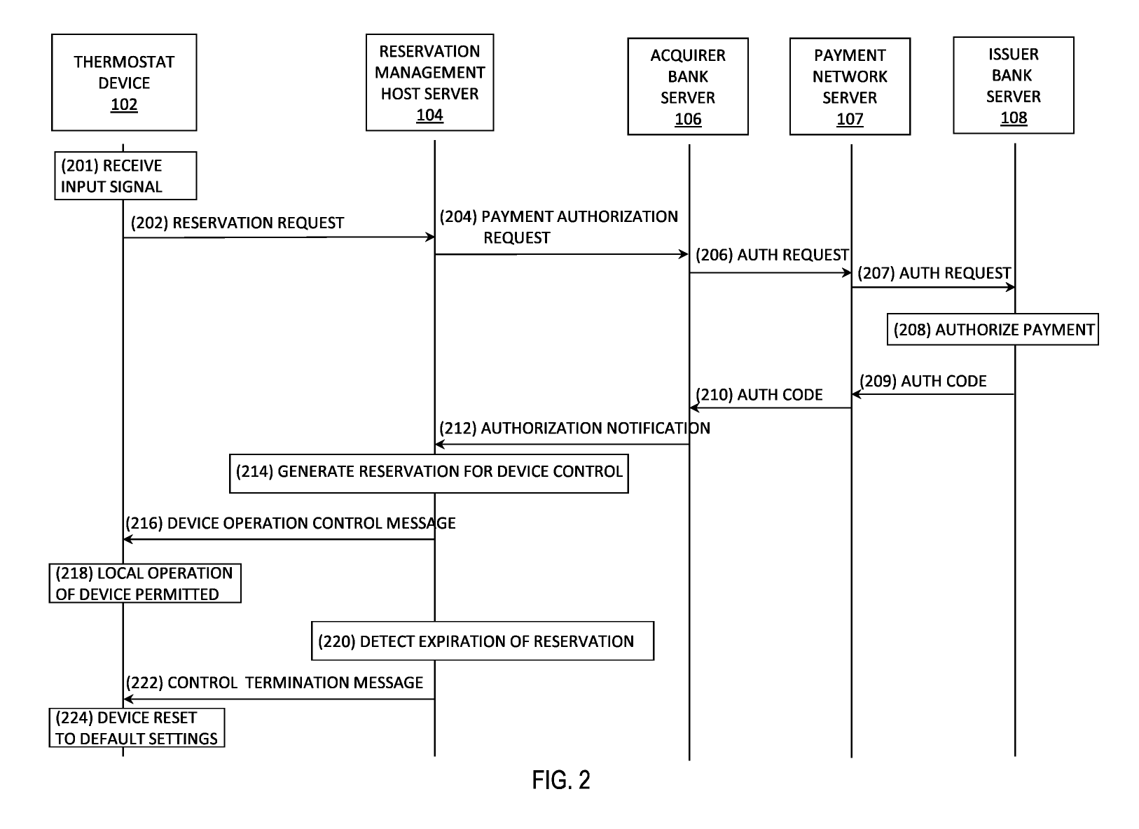

FIG. 2 is a diagram illustrating exemplary electronic messaging exchanged between various network entities for electronically managing the operation of a thermostat device according to an embodiment of the subject matter described herein. As shown in FIG. 2, the system entities associated with the disclosed subject matter include thermostat device 102, reservation management host server 104, acquirer bank server 106, issuer bank server 108, and utility entity server (i.e., the same elements described above with regard to FIG. 1). FIG. 2 further depicts a payment network processing server 107, which may include any server or host managed and operated by a payment card network entity (e.g., a credit card company) that is configured to process purchase transactions conducted via a payment card (e.g., a credit card, debit card, etc.).

In block 201, an input signal is received by thermostat device 102. In some embodiments, the input signal comprises an NFC signal that is transmitted from a renter's user device to thermostat device 102. For example, the NFC signal may include payment credential data (e.g., payment card or credit card credential information) associated with a mobile smart phone user.

At line 202, a reservation request message is sent. In some embodiments, a reservation request message including the payment credential data provided by the renter's user device and a token identifier/PAN corresponding to thermostat device 102 is sent to the reservation management host server 104. The reservation request message may also indicate a duration (e.g., a range of dates, a number of days, etc.) of the reservation requested (e.g., entered by the renter via a thermostat device user interface). In some embodiments, the reservation request message is communicated via a packet-based network (e.g., the Internet).

At line 204, reservation management host server 104 sends a payment authorization request. In some embodiments, reservation management host server 104 may be configured to transmit a payment authorization request message to acquirer bank server 106 in response to receiving the payment credential data from thermostat device 102. In such a scenario, acquirer bank server 106 is associated with the acquiring bank entity that provides banking and/or payment card services to reservation management host server 104.

At line 206, a payment authorization request is sent to a payment network processing server. In some embodiments, acquirer bank server 106 forwards the payment authorization request message to a payment network processing server 107. In line 207, payment network processing server 107 forwards the payment authorization request message to issuer bank server 108, which subsequently authorizes the payment based on whether the associated payment card account includes sufficient funds and/or if credit is available (block 208). In such a scenario, issuer bank server 108 is associated with an issuing bank entity (e.g., determined using the payment credential data) that is responsible for issuing a payment card to the renter entity.

At line 209, an authorization code is sent. In some embodiments, issuer bank server 108 transmits a message containing the authorization code to payment network processing server 107upon authorizing the submitted payment credential data. Upon receipt of the authorization code, payment network processing server 107 forwards the message containing the authorization code to acquirer bank server 106 (line 210).

At line 212, an authorization notification is sent to the reservation management host server. In some embodiments, acquirer bank server 106 receives the message containing the authorization code and subsequently communicates an authorization notification message to inform reservation management host server 104 that the renter's payment credentials have been accepted (i.e., the payment and/or reservation request transaction has been authorized).

At block 214, a reservation for device control is generated. In some embodiments, reservation management host server 104 creates a reservation using the renter's payment credential data and the token identifier received from thermostat device 102. For example, reservation management host server 104 may use a calendar function (e.g., calendar function 116 in FIG. 1) that ties the renter's payment credential data (or a renter identifier derived from the credential data) to the token identifier for a designated time period. For example, the calendar function may be used to “block off” an amount of time associated with the thermostat device for the renter. By generating an exclusive reservation for the renter in this manner, reservation management host server 104 may avoid reservation conflicts for the thermostat device 102 (i.e., the calendar function will not “double-book” a time period for a thermostat device as represented by the token identifier).

In line 216, the reservation management host server sends a device operation control message to the thermostat device. In some embodiments, device manager 112 in reservation management host server 104 sends a device operation control message that is configured to trigger certain permissions on the thermostat device.

In block 218, the local operation of the thermostat device is permitted. In some embodiments, thermostat device 102 may be configured upon receiving the device operation control message to subsequently extract the device operation control message from the control message. Upon extracting (and decoding) the control message, a controller on thermostat device 102 may configure thermostat device 102 to permit and enable a renter to locally operate and/or control of thermostat device 102. For example, a touch screen or other user interface on thermostat device 102 may be enabled (and made operational to a renter) by the controller.

In block 220, the reservation management host server detects the expiration of the device reservation. In some embodiments, reservation management host server 104 utilizes a clock function (not shown) that keeps track of the current date and time. In the event the current date and time matches for exceeds a recorded value associated with determination of the reservation time, a device manager on reservation management host server 104 generates a control termination message.

In line 222, a control termination message is sent. In some embodiments, reservation management host server 104 sends a control termination message to thermostat device 102. The control termination message sent by reservation management host server 104 may include an instruction that, when received by thermostat device 102, instructs thermostat device 102 to terminate local operation (e.g., cease control capability by a renter) and reset thermostat device to any predefined default settings (block 224).

It will be appreciated that FIG. 2 is for illustrative purposes only and that various messages, message sequencing and/or message content described above in relation to FIG. 2 may be changed, altered, edited, or removed where necessary. For example, some messages may be separated or combined into more than one or less than one message.

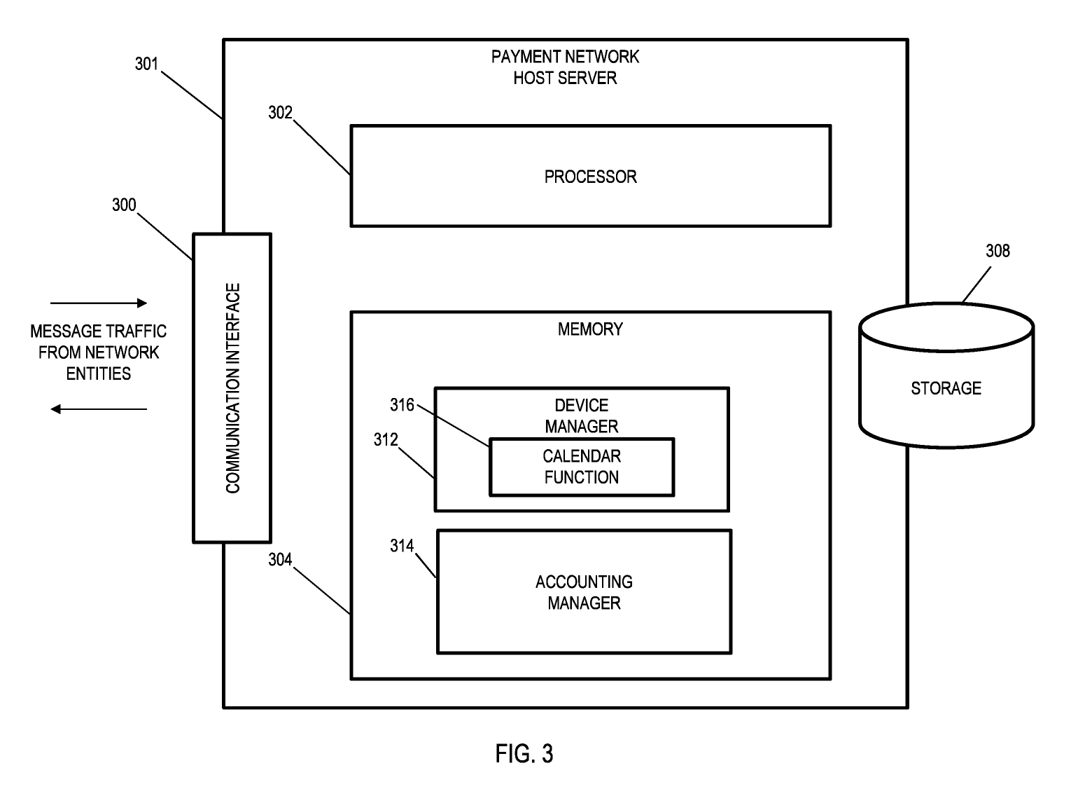

FIG. 3 is a block diagram illustrating an exemplary special purpose machine or device for electronically managing the operation of a thermostat device according to an embodiment of the subject matter described herein. FIG. 3 illustrates reservation management host server 301, which includes at least one communication interface 300, at least one processor 302, and at least one memory 304 (e.g., a memory component, element or device). In some embodiments, reservation management host server 301 includes a device manager 112 stored in memory 304 and is configured to utilize interface 300, processor 302, and memory 304 for executing an algorithm to communicate information (e.g., via an API-API exchange) with a thermostat device (e.g., thermostat device 102 in FIG. 1) and one or more bank entities (e.g., an acquirer bank server 106 and/or an issuer bank server 108 in FIG. 1) to facilitate the localized operation of a thermostat device. In some embodiments, packets or message traffic (e.g., reservation requests, electronic payment requests, payment information, transaction information, or the like) is sent, received and/or otherwise communicated or exchanged between device manager 312 and other network entities via communication interface 300. Although only one communications interface 300 is illustrated, one or more additional communications interfaces may be provided whereby connections to a packet network (e.g., network 115 as shown in FIG. 1) and other entities are established. That is, communications interface 300 may include an interface by which packet data messages are received, sent, and/or exchanged.

In some embodiments, communications interface 300 is utilized by device manager 312 to transfer and exchange electronic payment card information, electronic monetary funds, reservation information, payment card account information, and any other information by which device manager 312 can collect, store, and ultimately facilitate the requested reservation of the localized operation of a thermostat device. Device manager 312 is further configured to receive reservation request data which indicates that a renter authorizes an advance payment for thermostat device operation and control at a rental property, to receive payment authorization information in order to send device operation control messages to appropriate thermostat devices, to communicate with utility service entities and/or weather service entities to obtain usage data and climate data that may be used to derive an estimated price point for locally operating a thermostat device. Device manager 312 is further configured to utilize the renter's payment credential data and a thermostat device's token PAN/identifier to reserve a requested time period in accordance to a schedule defined by a calendar function 316. Server 301 may also be configured with an accounting manager 314 which serves to manage thermostat device account information and present such information to the rental property owner via a historical usage report. For example, accounting manager 114 may generate reports by which the rental property owner can utilize to assess historical power consumption and/or usage metrics and billed amounts associated with a thermostat device.

In some embodiments, processor 302 includes a microprocessor, such as a central processing unit (CPU), or any other hardware-based processor unit. Processor 302 is configured to execute and/or utilize software to communicate with thermostat device 102 (as shown in FIG. 1) and any platforms associated therewith, for electronically reserving and managing the local operation of a thermostat device, so that settlement of the advance payment occurs in accordance with the reservation request.

In some embodiments, device manager 312 further comprises a module that is executed by processor 302 and stored in memory 304. Device manager 312 may include hardware, software and/or firmware components for implementing the electronic management of a thermostat device as described herein. In one exemplary implementation, device manager 312 includes functionality for receiving historical usage information and/or forecasted weather information, and managing the funds for delivery to a rental property owner (e.g., a bank account belonging to a rental property owner via platform 108 as shown in FIG. 1). Storage 308 can comprise any type of storage element, component, or device, not limited to a database, a data table, a cache, a storage drive, or any other collection of records or information including payment information for processing on a periodic basis.

In some embodiments, device manager 312 includes functionality for reading, parsing, and/or otherwise processing APIs to map a price point payment amount to a period of time (e.g., a range of dates) associated with a rental property identified by a token identifier. Further, device manager 312 is configured to support various APIs and communicate with a utility entity server to obtain/pull historical HVAC usage and payment data in the manner described above.

In some embodiments, memory 304 (e.g., a memory element or device) of manager 112 includes a random access memory (RAM), a read only memory (ROM), an optical read/write memory, a cache memory, a magnetic read/write memory, a flash memory, or any other non-transitory storage media. In some embodiment, processor 302 and memory 304 may be used to execute and manage the operation of device manager 312. In some embodiments, memory 304 and/or storage 308 include any medium that is configured to locally store reservation request data, payment credential data, and calendar data used in processing reservations for the local operation of thermostat devices.

Although FIG. 3 depicts reservation management host server 301 as a single node or network element, reservation management host server 301 may alternatively comprise a plurality of network elements or components without departing from the scope of the present subject matter. Reservation management host server 301 may include multiple processors, memory elements, interfaces, or the like. Further, reservation management host server 301 is a special purpose computing device or machine having hardware components (e.g., one or more processor units, memory, and network interfaces) configured to execute hardware and software elements (e.g., APIs, packets, modules, etc.) for the purposes of performing one or more aspects of the disclosed subject matter. In addition, it should be noted that reservation management host server 301 and the components or functionality thereof constitute special purpose computers that improve the technological field pertaining to the management of thermostat devices.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

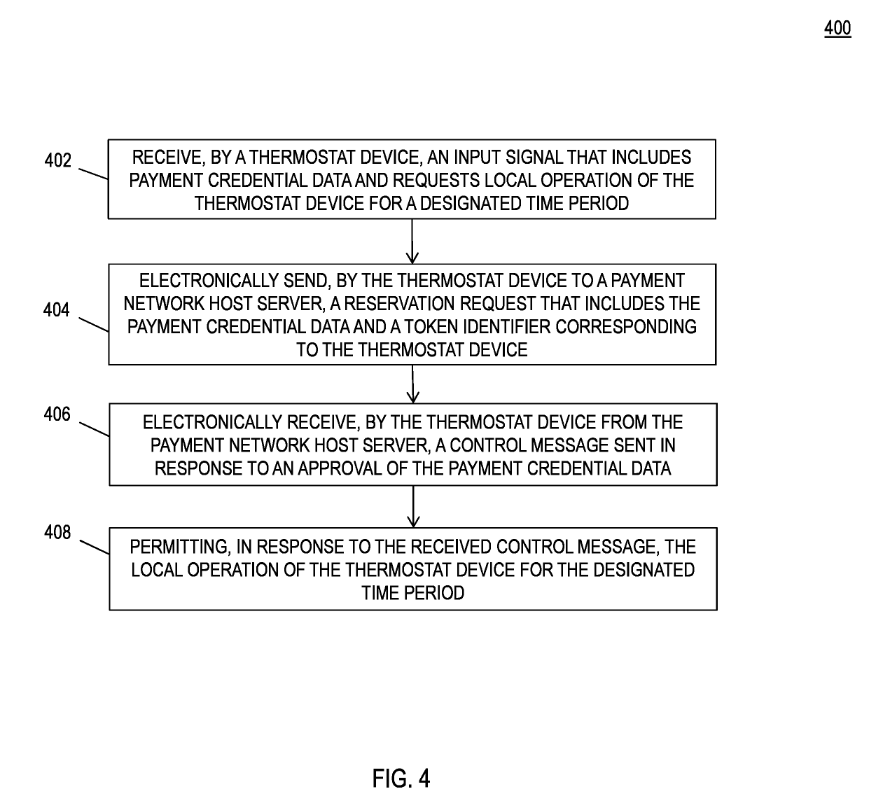

FIG. 4 is a diagram illustrating an exemplary method 400 for electronically managing the operation of a thermostat device according to an embodiment of the subject matter described herein.

In block 402, an input signal that includes payment credential data is electronically received by a thermostat device. In some embodiments, the thermostat device may electronically receive the input signal communicated from a user device via a wireless technology, such as NFC or RFID. Further, the input signal may also include payment credential data (e.g., renter's credit card credentials) that is similarly stored in the renter's mobile device.

In block 404, a reservation request message corresponding to the thermostat device is electronically sent to the reservation management host server. In some embodiments, the thermostat device transmits a reservation request message that includes i) the renter's payment credential data, ii) a token identifier that identifies the thermostat device, and iii) the requested reserved time period. The renter may utilize a user interface on the thermostat device to provide an indication of a requested time period (e.g., a particular week; the next “n” number of days, etc.) in which the renter wishes to be able to locally operate the thermostat device within the rental property. In some embodiments, the reservation request message may comprise a packet-based message that includes an origination address that includes the thermostat device's IP address or the IP address of an associated router and/or modem serving the thermostat device.

In block 406, a control message is electronically received by the thermostat device. In some embodiments, the thermostat device receives a control message from the reservation management host server in response to the host server requesting and subsequently receiving approval (e.g., from an acquirer bank server) of the payment credential data being used for the reservation request transaction.

In block 408, local operation of the thermostat device is permitted in response to the received control message. In some embodiments, the thermostat device extracts and reads a command code in the control message. Notably, a recognized command code may trigger a controller to allow a renter local access to and control of the thermostat device.

It will be appreciated that exemplary process 400 is for illustrative purposes only and that different and/or additional actions may be used. It will also be appreciated that various actions associated with exemplary process 400 may occur in a different order or sequence.

It will be understood that various details of the subject matter described herein may be changed without departing from the scope of the subject matter described herein. Furthermore, the foregoing description is for the purpose of illustration only, and not for the purpose of limitation. For example, various combinations and sub-combinations of the structures and features described herein are contemplated, and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method comprising:
receiving, by a thermostat device, an input signal requesting local operation of the thermostat device for a designated time period, wherein the input signal includes payment credential data;
electronically sending, by the thermostat device to a reservation management host server, a reservation request message including the payment credential data and a token identifier corresponding to the thermostat device;
electronically receiving, by the thermostat device from the reservation management host server, a control message sent in response to an approval of the payment credential data; and
permitting, in response to the received control message, the local operation of the thermostat device for the designated time period.

2. The method of claim 1 wherein the input signal includes a near field communications (NFC) signal transmitted from a user device.

3. The method of claim 1 wherein the token identifier is a token personal account number (PAN) mapped to a personal account number associated with an owner of the thermostat device.

4. The method of claim 1 wherein the reservation management host server generates and sends the control message to the thermostat device in response to receiving an authorization notification message from an acquirer bank server.

5. The method of claim 1 wherein the reservation management host server utilizes the token identifier and the payment credential data to create an exclusive reservation for operating the thermostat device for a duration defined by the designated time period.

6. The method of claim 1 wherein the thermostat device is an Internet protocol (IP) addressable device that is configured to communicate with the reservation management host server via a packet-based network.

7. The method of claim 1 wherein the thermostat device reverts to a default setting and terminates the local operation upon an expiration of the designated time period.

8. A system comprising:
a thermostat device configured to receive an input signal requesting local operation of the thermostat device for a designated time period, wherein the input signal includes payment credential data, and to electronically send a reservation request message including the payment credential data and a token identifier corresponding to the thermostat device
a reservation management host server configured to receive the reservation request message, to obtain approval for the payment credential data, and to send a control message to the thermostat device in response to the approval of the payment credential data, wherein the local operation of the thermostat device is permitted for the designated time period in response to the control message being received by the thermostat device.

9. The system of claim 8 wherein the input signal includes a near field communications (NFC) signal transmitted from a user device.

10. The system of claim 8 wherein the token identifier is a token personal account number (PAN) mapped to a personal account number associated with an owner of the thermostat device.

11. The system of claim 8 wherein the reservation management host server is further configured to generate and send the control message to the thermostat device in response to receiving an authorization notification message from an acquirer bank server.

12. The system of claim 8 wherein the reservation management host server is further configured to utilize the token identifier and the payment credential data to create an exclusive reservation for operating the thermostat device for a duration defined by the designated time period.

13. The system of claim 8 wherein the thermostat device is an Internet protocol (IP) addressable device that is configured to communicate with the reservation management host server via a packet-based network.

14. The system of claim 8 wherein the thermostat device reverts to a default setting and terminates the local operation upon an expiration of the designated time period.

15. A non-transitory computer readable medium having stored thereon executable instructions that when executed by the processor of a computer control the computer to perform steps comprising:
receiving, by a thermostat device, an input signal requesting local operation of the thermostat device for a designated time period, wherein the input signal includes payment credential data;
electronically sending, by the thermostat device to a reservation management host server, the payment credential data and a token identifier corresponding to the thermostat device;
electronically receiving, by the thermostat device from the reservation management host server, a control message sent in response to an approval of the payment credential data; and
permitting, in response to the received control message, the local operation of the thermostat device for the designated time period.

16. The computer readable medium of claim 15 wherein the input signal includes a near field communications (NFC) signal transmitted from a user device.

17. The computer readable medium of claim 15 wherein the token identifier is a token personal account number (PAN) mapped to a personal account number associated with an owner of the thermostat device.

18. The computer readable medium of claim 15 wherein the reservation management host server generates and sends the control message to the thermostat device in response to receiving an authorization notification message from an acquirer bank server.

19. The computer readable medium of claim 15 wherein the reservation management host server utilizes the token identifier and the payment credential data to create an exclusive reservation for operating the thermostat device for a duration defined by the designated time period.

20. The computer readable medium of claim 15 wherein the thermostat device is an Internet protocol (IP) addressable device that is configured to communicate with the reservation management host server via a packet-based network.
